(19) United States
(12) Patent Application Publication
(10) Pub. No.: US 2025/0272450 A1
(43) Pub. Date: Aug. 28, 2025

(54) SYSTEMS AND METHODS FOR AUTOMATED CABLE DIAGRAM GENERATION IN AN INFORMATION HANDLING SYSTEM

(71) Applicant: Dell Products L.P., Round Rock, TX (US)

(72) Inventors: Chung-En LIU, Taipei City (TW); Michael J. STUMPF, Cedar Park, TX (US); Tsung-Jing CHEN, Taipei City (TW); Timothy M. LAMBERT, Austin, TX (US)

(73) Assignee: Dell Products L.P., Round Rock, TX (US)

(21) Appl. No.: 18/590,599

(22) Filed: Feb. 28, 2024

(51) Int. Cl. G06F 30/17

(52) U.S. Cl. CPC G06F 30/17

(57) ABSTRACT

An information handling system may include a processor and a management controller configured to provide out-of-band management facilities for management of the information handling system, the management controller further configured to access multiple data sources that describe an electrical connectivity topology of the information handling system and based on the multiple data sources, automatically and dynamically generate at least one image for display, the at least one image showing suggested routing and coupling for electrical connectivity among information handling resources of the information handling system.

### TECHNICAL FIELD

The present disclosure relates in general to information handling systems, and more particularly to systems and methods for automated generation of a cable diagram in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system servers continue to increase in complexity, with complexity expected to increase as signaling speeds in information handling systems increase. Such faster speeds drive greater use of cables (e.g., in lieu of signal routing through circuit boards) to maintain desired levels of signal integrity. Accordingly, over time information handling systems are becoming increasingly more crowded with cables with increasingly identical or similar cable connections.

While existing technologies allow for detect and report cable misconfigurations, with dozens of cable connections in an information handling system, it may be difficult for a user to find the misconfigured cables and/or cable connectors.

Further, many similar information handling system configurations may differ by only a few cables. Thus, with even a few cables missing, a user may accidentally be using a different configuration than intended.

It may be challenging to route all of the required cables in a complex system, particularly when there is a need to add an additional cable to support certain features.

Accordingly, approaches that simplify routing of cables in an information handling system may be desired.

### SUMMARY

In accordance with the teachings of the present disclosure, the disadvantages and problems associated with cabling in an information handling system may be reduced or eliminated.

In accordance with embodiments of the present disclosure, an information handling system may include a processor and a management controller configured to provide out-of-band management facilities for management of the information handling system, the management controller further configured to access multiple data sources that describe an electrical connectivity topology of the information handling system and based on the multiple data sources, automatically and dynamically generate at least one image for display, the at least one image showing suggested routing and coupling for electrical connectivity among information handling resources of the information handling system.

In accordance with these and other embodiments of the present disclosure, a method may include accessing multiple data sources that describe an electrical connectivity topology of the information handling system and based on the multiple data sources, automatically and dynamically generating at least one image for display, the at least one image showing suggested routing and coupling for electrical connectivity among information handling resources of the information handling system.

In accordance with these and other embodiments of the present disclosure, an article of manufacture may include a computer readable medium and computer-executable instructions carried on the computer readable medium, the instructions readable by a processor, the instructions, when read and executed, for causing the processor to, in a management controller configured to provide out-of-band management facilities for management of an information handling system: access multiple data sources that describe an electrical connectivity topology of the information handling system and based on the multiple data sources, automatically and dynamically generate at least one image for display, the at least one image showing suggested routing and coupling for electrical connectivity among information handling resources of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example webpage that may be displayed to a user showing a plan view of an information handling system with suggested cable routing for cables and coupling of cables to connectors of components of the information handling system based on the desired configuration of the information handling system, in accordance with embodiments of the present disclosure;

FIG. 3 illustrates an example series of images conveying to a user a series of steps for re-cabling an information handling system to change between configurations of the information handling system, in accordance with embodiments of the present disclosure;

FIG. 4 illustrates an example series of images conveying to a user a remedy for a cabling error within the information handling system, in accordance with embodiments of the present disclosure;

FIG. 5 illustrates an example image conveying to a user an end-to-end topology for an input/output signal within the information handling system, in accordance with embodiments of the present disclosure;

FIG. 6 illustrates an example image illustrating automatic tracing of endpoint routing for a device, in accordance with embodiments of the present disclosure;

FIGS. 7A and 7B respectively illustrate an Inter-Integrated Circuit (I2C) sideband from a management controller wired to a connector and an I2C sideband from a management controller not wired to a connector, in accordance with embodiments of the present disclosure; and

FIG. 8 illustrates a block diagram of an example information handling system having a cable routing area, in accordance with embodiments of the present disclosure.

### DETAILED DESCRIPTION

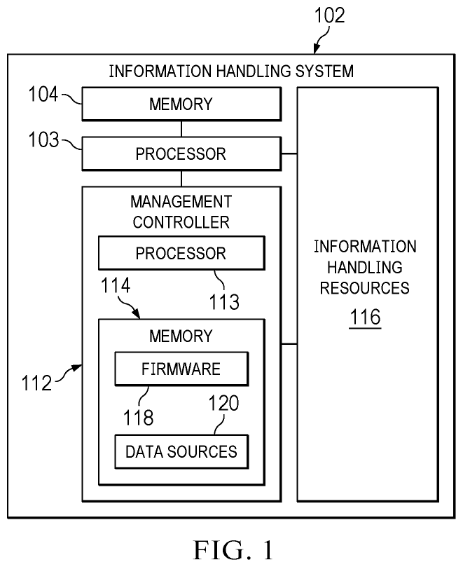

Preferred embodiments and their advantages are best understood by reference to FIGS. 1 through 8, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server. In other embodiments, information handling system 102 may be a personal computer (e.g., a desktop computer, a laptop, notebook, tablet, handheld, smart phone, personal digital assistant, etc.). As depicted in FIG. 1, information handling system 102 may include a processor 103, a memory 104 communicatively coupled to processor 103, a management controller 112 communicatively coupled to processor 103, and one or more information handling resources 116 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Management controller 112 may be configured to provide out-of-band management facilities for management of information handling system 102. Such management may be made by management controller 112 even if information handling system 102 is powered off or powered to a standby state. Management controller 112 may include a processor 113, memory 114, and an out-of-band network interface separate from and physically isolated from an in-band network interface. In certain embodiments, management controller 112 may include or may be an integral part of a baseboard management controller (BMC), a remote access controller (e.g., a Dell Remote Access Controller of Integrated Dell Remote Access Controller), or an enclosure controller. In other embodiments, management controller 112 may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in computer-readable media of information handling system 102 or management controller 112 (e.g., memory 114). As shown in FIG. 1, processor 113 may be communicatively coupled to processor 103. Such coupling may be via a Universal Serial Bus (USB), System Management Bus (SMBus), general purpose input/output (GPIO) channel and/or one or more other communications channels.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. Memory 114 may have stored thereon software and/or firmware which may be read and executed by processor 113 for carrying out the functionality of management controller 112. As shown in FIG. 1, memory 114 may have stored thereon firmware 118 and data sources 120.

Firmware 118 may include a program of executable instructions configured to be read and executed by processor 113 in order to carry out the functionality of management controller 112, including functionality of management controller 112 described herein.

Data sources 120 may comprise one or more tables, lists, maps, and/or any other suitable data structures that may, based on a desired configuration of information handling system 102, be leveraged by firmware 118 to automatically generate a cabling diagram to a user in order to aid the user in correctly cabling together components of information handling system 102 to specifically achieve the desired configuration.

Data sources 120 that may be leveraged by firmware 118 may comprise any suitable “centers of truth,” including without limitation:
geography data regarding a planar/motherboard for information handling system 102;
multiple photographic layers for the planar/motherboard of information handling system 102 and/or the chassis/enclosure housing components of information handling system 102;
geometry data for cables;
photographs of cables;
pixel density information regarding the photographs of cables and/or photographic layers of planar/motherboard and chassis;
a cable matrix/table;
silkscreen data for connectors of information handling system 102 (e.g., from schematics and/or netlists);
riser configuration (e.g., from a map of riser slot numbers);
storage configuration (e.g., from a backplane map);
PowerEdge Portfolio Configuration Matrix data (or any other data relating to a validated/shipped physical configuration of information handling system 102); and
Slot Priority Matrix data (or any other data that defines which cards and adapters are supported in each slot in information handling system 102).

Firmware 118 may display such generated cabling diagram to a user, for example via a web interface of management controller 112 (e.g., via a management console remotely coupled to management controller 112 or via accessing management controller 112 through an operating system executing on processor 103).

In some embodiments, data sources 120 may be stored elsewhere (e.g., on the Internet or the “cloud”) and the functionality of firmware 118, as it relates to generating images of cabling, may be executed by such remote system to display generated cabling diagrams to users.

Generally speaking, information handling resources 116 may include any component system, device or apparatus of information handling system 102, including without limitation processors, buses, computer-readable media, input-output devices and/or interfaces, storage resources, network interfaces, motherboards, electro-mechanical devices (e. g., fans), displays, and/or power supplies.

Although not shown in FIG. 1 for the purposes of clarity and exposition, various components of information handling system 102 may be electrically and/or communicatively coupled to one another via cables of electrically conductive wire. For example, processor 103 may be coupled to one or more of information handling resources 116 via one or more cables, management controller 112 may be coupled to one or more of information handling resources 116 via one or more cables, and some of information handling resources 116 may be coupled to one another via cables.

As described above, firmware 118 may be configured to display to a user a cabling diagram based on data sources 120. The figures described below depict the types of cabling diagrams that may be displayed.

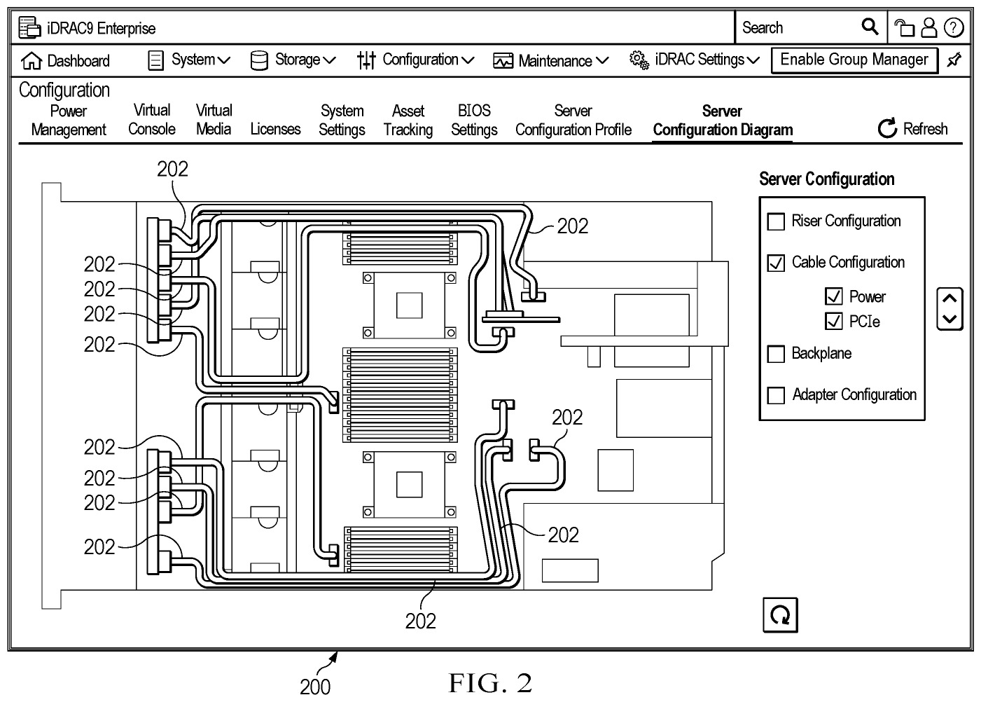

For example, FIG. 2 illustrates an example webpage 200 that may be displayed to a user showing a plan view of information handling system 102 with suggested cable routing for cables 202 and coupling of cables 202 to connectors of components of information handling system 102 based on the desired configuration of information handling system 102.

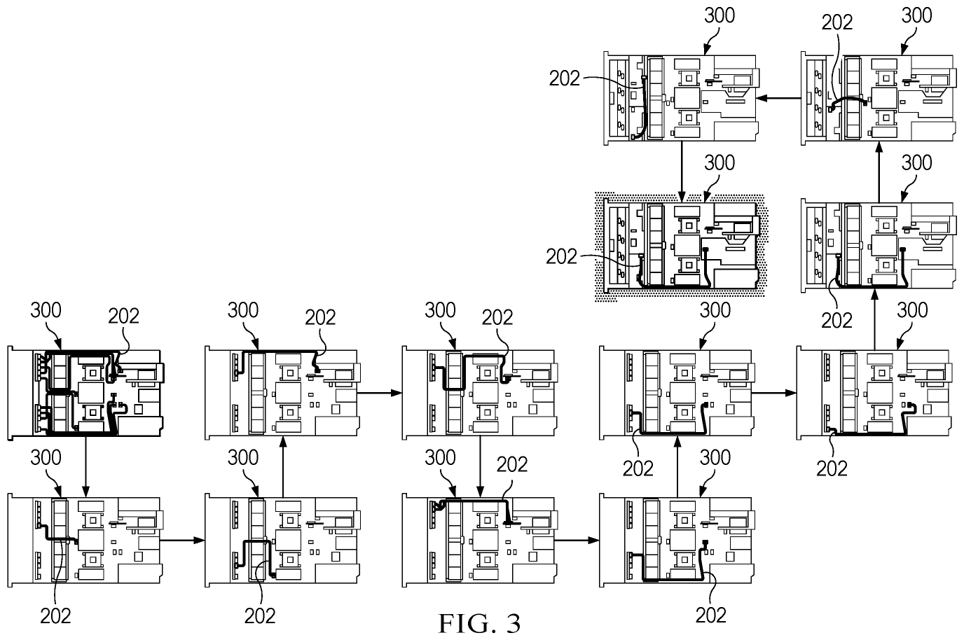

From time to time, a configuration of information handling system 102 may change. Accordingly, in some embodiments, firmware 118 may be configured to, based on data sources 120, automatically and dynamically generate differences in cabling from one configuration to another, and display one or more images 300 to the user that depict a series of steps for re-cabling of cables 202 of information handling system 102, as shown in FIG. 3.

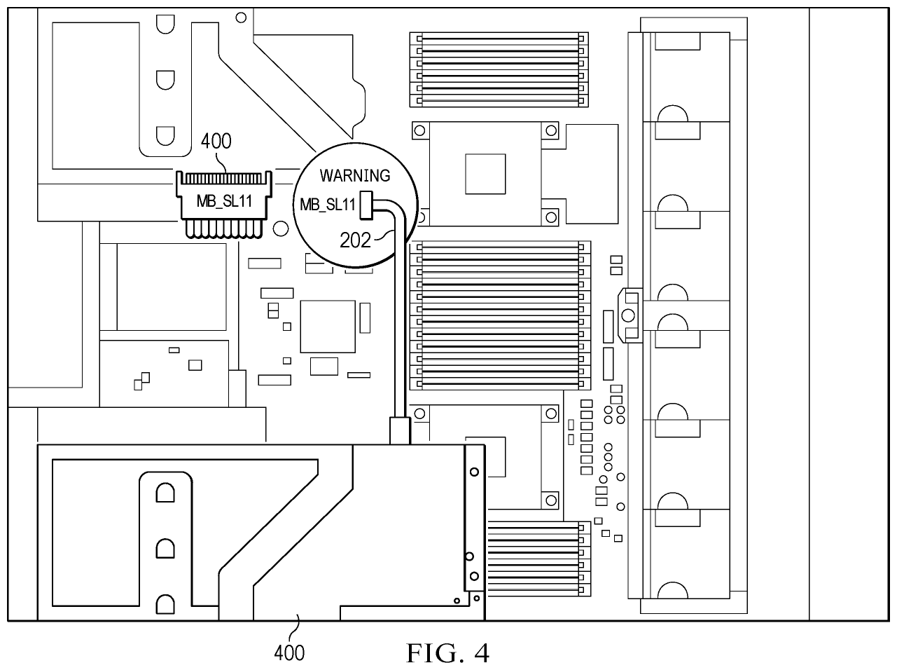

As a further example, firmware 118 may (either automatically or in response to user command) perform a configuration validation of information handling system 102. During such configuration validation, firmware 118 may be able to determine if any cables are missing from information handling system 102 and/or if any cables are incorrectly coupled to components of information handling system 102. For any incorrect and/or missing cabling, firmware 118 may automatically and dynamically generate images to the user detailing how to remedy the missing and/or incorrectly coupled cable 202, as shown in FIG. 4. Such images may include, without limitation, identification of the incorrect and/or missing cable and pictorial representations of remedying the incorrect and/or missing cable. In some embodiments, such images may display silkscreens 400 representative of the connector and/or device to which the cable 202 is incorrectly coupled and/or to which the cable 202 should be connected to remedy the error.

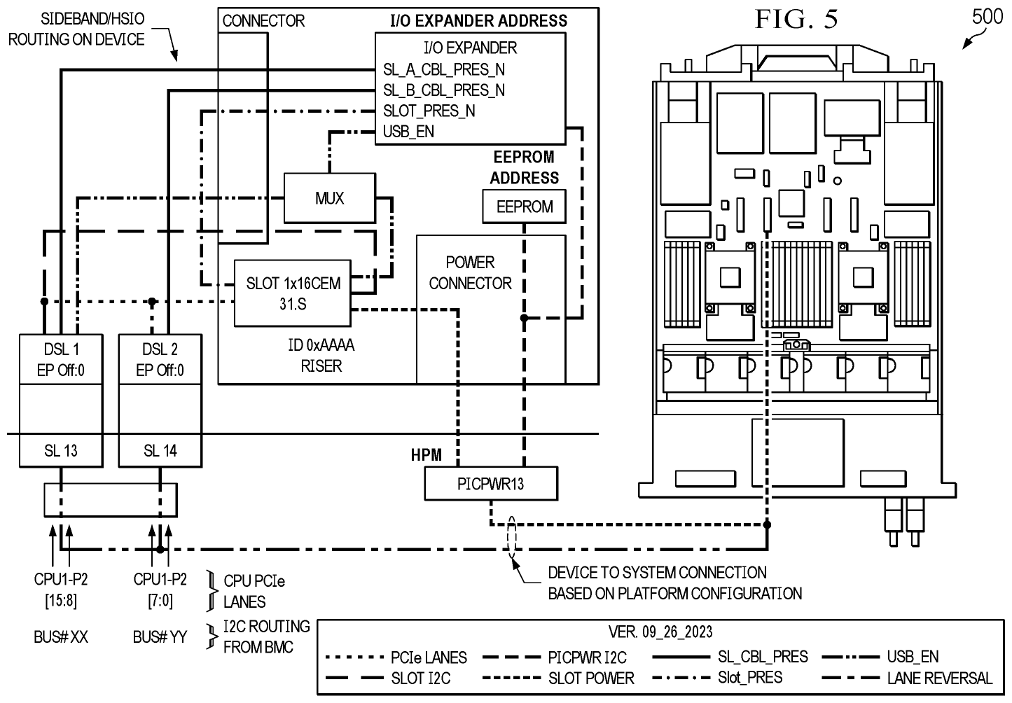

As an additional example, firmware 118 may be configured to, based on data sources 120, automatically and dynamically generate end-to-end input/output routing of a signal. For example, as shown in FIG. 5, firmware 118 may automatically generate an image 500 depicting an end-to-end topology from a planar to a device slot, wherein each segment of the topology may be extracted from data sources 120, such as a riser connection to a planar based on a riser configuration, a payload of the device, signal routing from a processor to a connector of the planar, and sideband routing from a management controller to the planar connector. Such image may be useful not only to an end-user or technician/administrator of information handling system 102, but may also be useful to a system designer of information handling system 102 during product development.

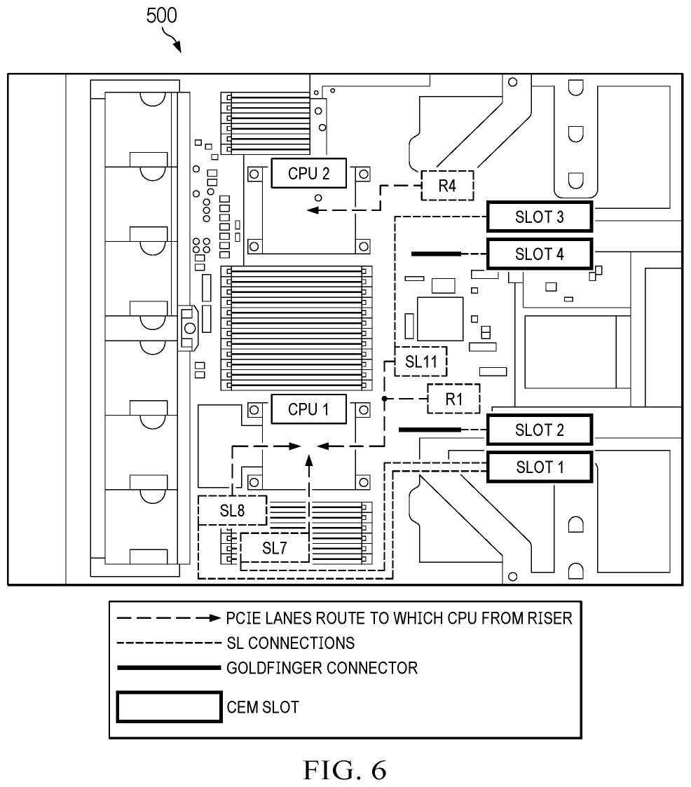

As an extension of the concept of image 500 shown in FIG. 5, firmware 118 may be configured to, based on data sources 120, perform automatic tracing of endpoint routing for a device, as shown in FIG. 6, and suggest to a user where to install an endpoint device to maximize balancing among input/output devices. In other words, because available input/output lanes left per processor may be known, and it may be known which input/output device slots can support which input/output devices, firmware 118 may suggest the “best” available slot when multiple slots are available for the user to install a certain input/output device to maximize balanced loading on processors.

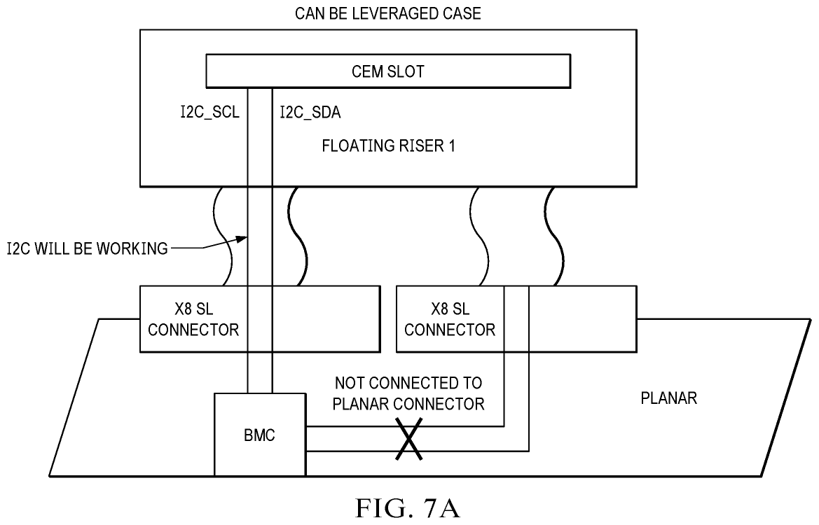

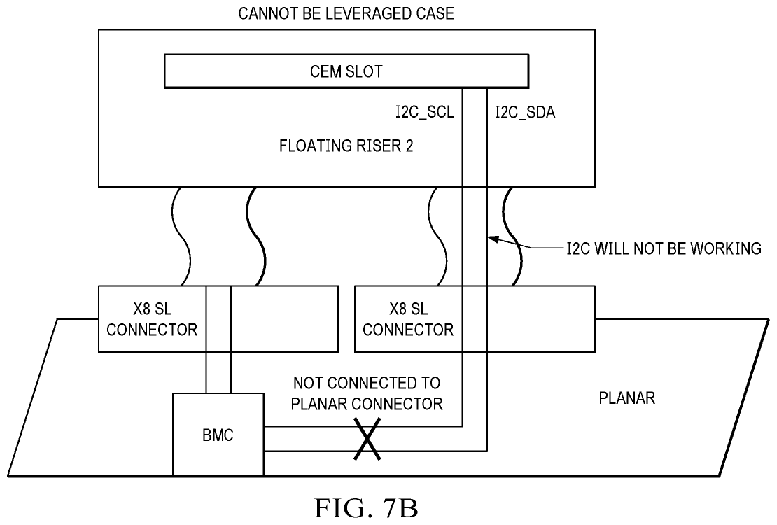

As another example, based on data sources 120, and in particular data from design schematics of information handling system 102, firmware 118 may be configured to determine whether an existing component may be leveraged in a new design. To illustrate, while many designs of information handling systems strive to be generic, many others are ultimately purpose-built and non-standard. For example, as shown in FIGS. 7A and 7B, in some instances, an Inter-Integrated Circuit (I2C) sideband from a management controller may not be wired to a connector. Based on such wiring information present in schematics, firmware 118 may be able to determine if components from one information handling system design may be leveraged for use in designing a new information handling system.

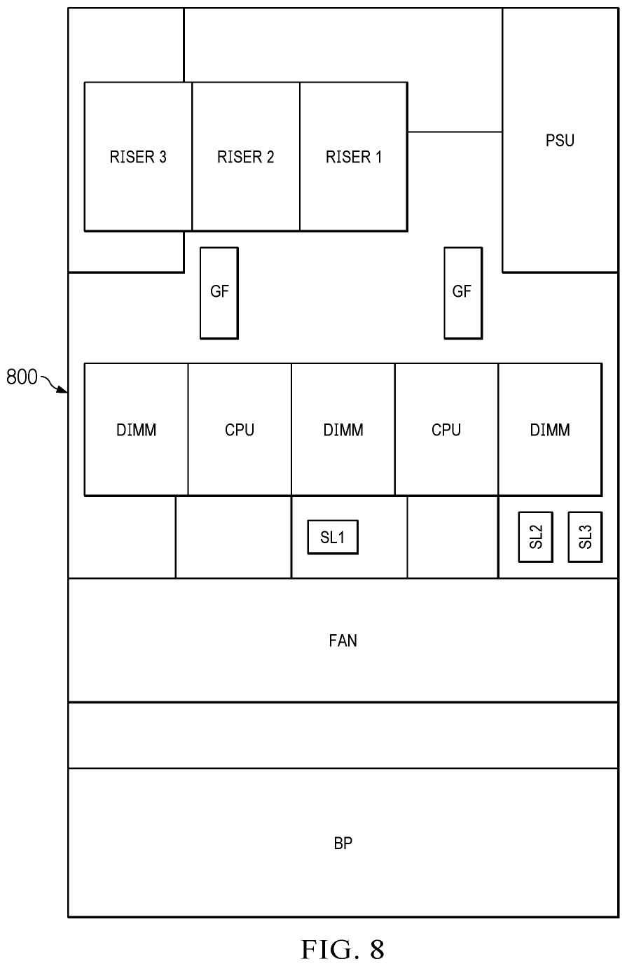

As yet another example, as shown in FIG. 8, based on data sources 120, including available cable routing area 800 in information handling system 102 and cable routing restrictions, firmware 118 may be configured to automatically generate a cable routing plan which is cost-optimized (e.g., in terms of shortest runs of cable length) and speed-optimized, which may be useful in system design of information handling system 102 during development.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An information handling system comprising:
a processor; and
a management controller configured to provide out-of- band management facilities for management of the information handling system, the management controller further configured to:
access multiple data sources that describe an electrical connectivity topology of the information handling system; and
based on the multiple data sources, automatically and dynamically generate at least one image for display, the at least one image showing suggested routing and coupling for electrical connectivity among information handling resources of the information handling system.

2. The information handling system of claim 1, wherein:
the multiple data sources describe a cable topology of the information handling system; and
the at least one image shows suggested cable routing and coupling for cables among information handling resources of the information handling system.

3. The information handling system of claim 2, wherein the at least one image shows a series of steps for re-cabling of the cables to transition the information handling system from one configuration to another configuration.

4. The information handling system of claim 2, wherein the at least one image shows a series of steps for remedying a cabling error within the information handling system.

5. The information handling system of claim 1, wherein the at least one image shows an end-to-end topology for an input/output signal within the information handling system.

6. The information handling system of claim 1, wherein the management controller is further configured to:
based on the multiple data sources, perform automatic tracing of endpoint routing for a device; and
based on such automatic tracing, suggest a location of an endpoint device to optimize a characteristic among input/output devices.

7. The information handling system of claim 1, wherein the management controller is further configured to, based on the multiple data sources, determine if components from one information handling system design may be leveraged for use in designing a new information handling system.

8. The information handling system of claim 1, wherein the management controller is further configured to, based on the multiple data sources, automatically generate a cost-optimized and speed-optimized electrical routing plan for the information handling system.

9. A method comprising:
accessing multiple data sources that describe an electrical connectivity topology of an information handling system; and
based on the multiple data sources, automatically and dynamically generating at least one image for display, the at least one image showing suggested routing and coupling for electrical connectivity among information handling resources of the information handling system.

10. The method of claim 9, wherein:
the multiple data sources describe a cable topology of the information handling system; and
the at least one image shows suggested cable routing and coupling for cables among information handling resources of the information handling system.

11. The method of claim 10, wherein the at least one image shows a series of steps for re-cabling of the cables to transition the information handling system from one configuration to another configuration.

12. The method of claim 10, wherein the at least one image shows a series of steps for remedying a cabling error within the information handling system.

13. The method of claim 9, wherein the at least one image shows an end-to-end topology for an input/output signal within the information handling system.

14. The method of claim 9, further comprising:
based on the multiple data sources, performing automatic tracing of endpoint routing for a device; and
based on such automatic tracing, suggesting a location of an endpoint device to optimize a characteristic among input/output devices.

15. The method of claim 9, further comprising, based on the multiple data sources, determining if components from one information handling system design may be leveraged for use in designing a new information handling system.

16. The method of claim 9, further comprising, based on the multiple data sources, automatically generating a cost-optimized and speed-optimized cable routing plan for the information handling system.

17. An article of manufacture comprising:
a computer readable medium; and
computer-executable instructions carried on the computer readable medium, the instructions readable by a processor, the instructions, when read and executed, for causing the processor to, in a management controller configured to provide out-of-band management facilities for management of an information handling system:
access multiple data sources that describe an electrical connectivity topology of the information handling system; and
based on the multiple data sources, automatically and dynamically generate at least one image for display, the at least one image showing suggested routing and coupling for electrical connectivity among information handling resources of the information handling system.

18. The article of claim 17, wherein:
the multiple data sources describe a cable topology of an information handling system; and
the at least one image shows suggested cable routing and coupling for cables among information handling resources of the information handling system.

19. The article of claim 18, wherein the at least one image shows a series of steps for re-cabling of the cables to transition the information handling system from one configuration to another configuration.

20. The article of claim 18, wherein the at least one image shows a series of steps for remedying a cabling error within the information handling system.

21. The article of claim 17, wherein the at least one image shows an end-to-end topology for an input/output signal within the information handling system.

22. The article of claim 17, the instructions for further causing the processor to:
based on the multiple data sources, perform automatic tracing of endpoint routing for a device; and
based on such automatic tracing, suggest a location of an endpoint device to optimize a characteristic among input/output devices.

23. The article of claim 17, the instructions for further causing the processor to, based on the multiple data sources, determine if components from one information handling system design may be leveraged for use in designing a new information handling system.

24. The article of claim 17, the instructions for further causing the processor to, based on the multiple data sources, automatically generate a cost-optimized and speed-optimized cable routing plan for the information handling system.
